(19) United States
(12) Patent Application Publication
(10) Pub. No.: US 2023/0365223 A1
(43) Pub. Date: Nov. 16, 2023

(54) AUXILIARY MOTOR ARRANGEMENT AND SPROCKET MEMBER FOR A PEDAL-POWERED VEHICLE

(71) Applicant: CONNECT4ENGINEERING LTD, London (GB)

(72) Inventor: Bobby Singh, London (GB)

(21) Appl. No.: 18/246,072

(22) PCT Filed: Jan. 7, 2021
(86) PCT No.: PCT/GB2021/050039

§ 371 Date: Mar. 21, 2023

(30) Foreign Application Priority Data
Jan. 7, 2020 (GB) 2000188.9
Oct. 13, 2020 (GB) 2016251.7

(51) Int. Cl. B62M 6/70; B62M 6/55; B62M 6/45; F16H 55/30

(52) U.S. Cl. CPC B62M 6/70; B62M 6/45; B62M 6/55; F16H 55/30; B62M 6/90

(57) ABSTRACT

The present invention relates to an auxiliary drive arrangement for a pedal-powered vehicle having a drivetrain comprising a pedal- driven sprocket and chain (15B) for connecting pedals (34) to a driven wheel. The auxiliary drive arrangement comprises: an electric motor (6) arranged to be mounted to the vehicle; a power source (14) for the electric motor; and a sprocket member (24) comprising first and second sprockets (24A, 24B). The sprocket member is configured to be selectively attachable via an attachment formation to the drive train of the vehicle. The sprocket member is configured to be mounted on an existing pedal sprocket and operatively connected to the electric motor to provide a drive path from the electric motor to the pedal-driven sprocket via the sprocket member.

The present invention relates to an auxiliary motor arrangement for a human powered vehicle, particularly to an auxiliary motor transmission arrangement for a bicycle.

For cyclists covering longer distances or those who may be less physically able, electrically-powered bicycles are used to reduce the manual effort required. Electric bicycles have been increasing in popularity over recent years and a significant number of makes and models are available to the consumer.

However, electric bicycles are usually a bespoke construction and therefore are often expensive. Many existing cyclists may wish to consider electrical assistance but are deterred by the need to purchase a new bicycle, i.e. potentially making an existing bicycle redundant. Additionally, if a user wishes to use the bicycle in a conventional, non-powered fashion, the heavier construction and motor increases the effort required by the user. Therefore, a regular cyclist may have both an electric bicycle and a conventional bicycle.

An example of a power assisted electric bicycle can be found in U.S. Pat. No. 7963357, in which a bespoke rocker assembly is implemented for the drive wheel and gearwheel driven by the motor. This provides just one example of the complex and costly construction of dedicated electric bicycles.

It is an aim of the present invention to overcome or ameliorate one or more of the above problems.

According to a broad definition of the invention, there is provided an auxiliary drive system for a pedal bike having a motor mounted to the bike frame and a loop/chain that connects the motor into the pedal driven drivetrain of the bike via a sprocket member mounted at the pedals, the sprocket member being a one-way sprocket member, e.g. comprising a ratchet mechanism.

According to a first aspect of the invention, there is provided: an auxiliary drive arrangement for a pedal-powered vehicle having a drivetrain comprising a pedal-driven sprocket and a drive loop for connecting pedals to a driven wheel, the auxiliary drive arrangement comprising: an electric motor arranged to be mounted to the vehicle; a sprocket member configured to be selectively attachable via an attachment formation to the drive train of the vehicle, the sprocket member comprising a sprocket configured to be operatively connected to the electric motor and the pedal-driven sprocket of the vehicle.

A drive loop may provide a drive path from the electric motor to the pedal-driven sprocket, e.g. via the sprocket member. The drive loop may comprise a flexible tension member. The tension loop may comprise a chain or belt or the like.

The drive loop may comprise a single/closed loop (e.g. a single chain). The single drive loop may operatively connect the electric motor, the driven wheel and the sprocket member (i.e. provide a force path therebetween). The electric motor, driven wheel and sprocket member may be mounted in series in the drive loop.

The drivetrain of the vehicle may comprise a pedal-driven sprocket and the sprocket member may be configured to be mounted to the pedal-driven sprocket via the attachment formation.

The motor comprises a motor gear (e.g. a sprocket), the motor gear being connected to an output shaft of the motor. The motor gear may comprise a sprocket or wheel. The motor gear may engage the drive loop.

The axis of rotation of the motor gear may be offset from the axis of rotation of the motor (i.e. they may be laterally spaced).

The motor gear may be connected to an output shaft of the motor via a ratchet device (i.e. uni-directional ratchet device).

The auxiliary drive may comprise an adjustment means configured to provide adjustment of the position and/or orientation of the motor and/or motor gear relative to the sprocket member. The adjustment means may provide translation in one, two or three dimensions. The adjustment means may provide rotation in one, two or three dimensions.

The auxiliary drive may comprise a mounting means for mounting the motor to the vehicle, and the adjustment means provides adjustment of the position and/or orientation of the motor and/or motor gear relative to the mounting means.

The mounting means may provide a releasable attachment means to the vehicle. The mounting means may comprise a clamp. The clamp may comprise one or more U-shaped brackets. The clamp may engage a cage mount on the vehicle.

The motor gear may be offset toward the drive gear relative to the sprocket member (e.g. displaced from a leading edge of the sprocket member. An angle subtended between the motor gear, the sprocket member and a drive gear of the driven wheel may less than 110 degrees. An angle subtended between the motor gear, the sprocket member and a drive gear of the driven wheel may be 90 degrees.

The motor may be mounted to a seat tube of the vehicle (i.e. using the mounting means). The motor and/or motor gear may be mounted vertically above the sprocket member. The motor and/or motor gear may be mounted directly above the sprocket member (i.e. the respective axes of rotation thereof).

The motor and/or motor gear may be offset from a leading edge of the sprocket member (i.e. offset rearwardly from the sprocket member). The motor gear may be provided coplanar with the sprocket member.

The auxiliary drive may comprise a guide/tensioning mechanism. The guide/tensioning mechanism may be configured to adjust the effective path length and/or tension of the drive loop.

The guide/tensioning mechanism may be mounted to the motor. The guide/tensioning mechanism may be rotatably mounted to the motor. The guide/tensioning mechanism may be rotatable coaxially with the motor gear.

The guide/tensioning mechanism may comprise an arm (e.g. with one end rotatably mounted to the motor). The guide/tensioning mechanism may comprise a gear configured to retain the drive loop on the motor gear. The gear may be mounted to the arm (e.g. the free end thereof). The gear may be rotatable about, or relative to, the motor gear.

The drive loop may extend in a serpentine path about the guide/tensioning mechanism (e.g. the gear thereof) and the motor gear. The drive loop may pass around the motor gear by an angle of greater than 120°, 140° or 160°, e.g. an angle or equal to, or greater than, 180°.

The guide/tension mechanism and/or motor gear and/or motor may be provided as single unit/module.

The arm may provide a housing to enclose the motor gear and/or the tension gear.

The attachment formation may comprise a plurality of members selectively displaceable in a radial and/or circumferential direction.

The attachment formation may be configured to engage teeth of the pedal-driven sprocket of the drivetrain.

The attachment formation may be configured to engage a mounting structure for a chain guard on the pedal-driven sprocket of the drivetrain. The attachment formation may be configured to engage teeth on opposing sides of the pedal driven sprocket.

The attachment formation may comprise a fastener received within an aperture on the sprocket member, the fastener selectively engageable with the aperture to prevent relative movement there-between.

The aperture may be elongate in the form of a slot and the fastener is movable along the aperture such that the attachment formation is range-taking. The slots may be curved/arced. The slots may curve radially inwards.

The sprocket member may comprise a plurality of first slots and a plurality of second slots, where the circumferential spacing the first plurality of slots is different to the spacing of the second plurality of slots. The first and second slots may comprise different lengths.

The sprocket arrangement may comprise a central portion, a radially-outer portion and a plurality of spokes extending therebetween.

The aperture(s) may extend along one of the spokes.

The sprocket member may comprise a central aperture configured to permit a pedal of the vehicle to pass therethrough. The sprocket member may be annular in form.

The sprocket member may comprise first and second sprockets, the first sprocket of the sprocket member configured to operatively connected to the electric motor and the second sprocket of the sprocket member configured to be operatively connected to the pedal-driven sprocket of the vehicle

The attachment formation may be common to both the first sprocket and the second sprocket for common mounting of the first and second sprockets to the vehicle.

The first and second sprocket may be provided in side-by-side or coaxial arrangement on the sprocket member

The first and/or second sprocket may be rotatably mounted to the attachment formation of the sprocket member.

The first and/or second sprocket may be mounted to the attachment formation via a ratchet device configured to allow relative movement therebetween in a first direction and prevent relative movement therebetween in an opposing direction.

The arrangement may comprise a power source, e.g. for powering the electric motor. The power source may comprise a battery. The power source may comprise a rechargeable battery and a battery housing arranged to be mounted to the vehicle, the rechargeable battery being removably connected to the housing by a release mechanism.

The battery may be provided on the down tube on the vehicle. The battery may be fixed using a cage mount (e.g. on the down tube). The battery may connect into a conventional fixing point on the frame.

The arrangement may comprise user controls arranged to control the level of power supplied to the motor from the power source and/or the speed of the motor.

The arrangement may be provided in the form of a kit of parts for retrofit to an existing pedal-powered vehicle, the kit of parts comprising:
the electric motor;
a power source; and
the sprocket member.

According to a second aspect of the invention, there is provided: a non-powered vehicle or pushbike (e.g. bicycle, tricycle etc.) comprising the auxiliary drive arrangement of the first aspect of the invention.

The auxiliary drive arrangement may be retrofit onto the non-powered vehicle or pushbike

According to a third aspect of the invention, there is provided: an auxiliary drive arrangement for a pedal-powered vehicle having a drivetrain comprising a pedal-driven sprocket and chain for connecting pedals to a driven wheel, the auxiliary drive arrangement comprising: an electric motor arranged to be mounted to the vehicle; a power source for the electric motor; a sprocket member comprising first and second sprockets, the sprocket member configured to be selectively attachable via an attachment formation to the drive train of the vehicle, the first sprocket of the sprocket member configured to operatively connected to the electric motor and the second sprocket of the sprocket member configured to be operatively connected to the pedal-driven sprocket of the vehicle to provide a drive path from the electric motor to the pedal-driven sprocket via the sprocket member.

According to a fourth aspect of the invention, there is provided: sprocket member for a pedal-powered vehicle having a pedal assembly comprising pedals mounted for rotation about a pedal axis, the sprocket member comprising a sprocket and an attachment formation for mounting of the sprocket to the pedal assembly about the pedal axis, where the sprocket member comprises a ratchet mechanism arranged between the attachment formation and the sprocket.

The ratchet mechanism may be additional to a ratchet provided between the pedals and a conventional pedal sprocket, e.g. a conventional pedal mounted ratchet. The ratchet mechanism may be addition to a ratchet mechanism on the rear wheel of the bike.

Practicable embodiments of the invention are described in further detail below, by way of example only, with reference to the accompanying drawings, of which:

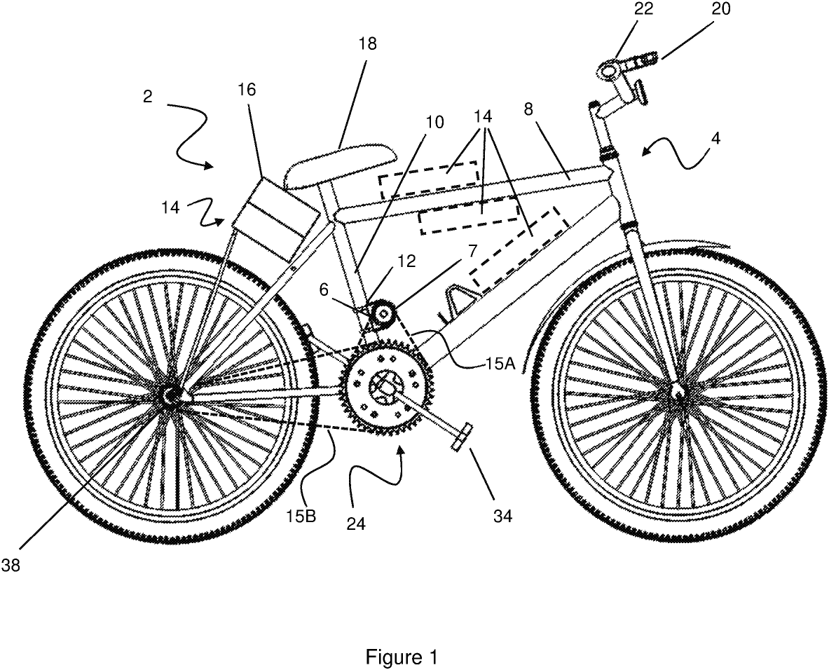

FIG. 1 shows a side view of a first embodiment of an auxiliary motor arrangement mounted to a bicycle;

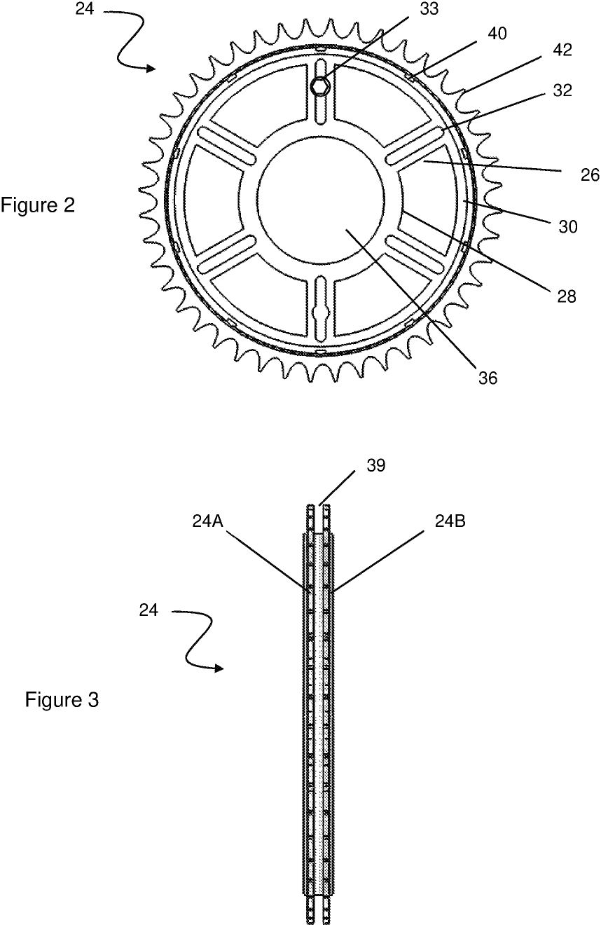

FIG. 2 shows a plan view of a first embodiment of a sprocket member;

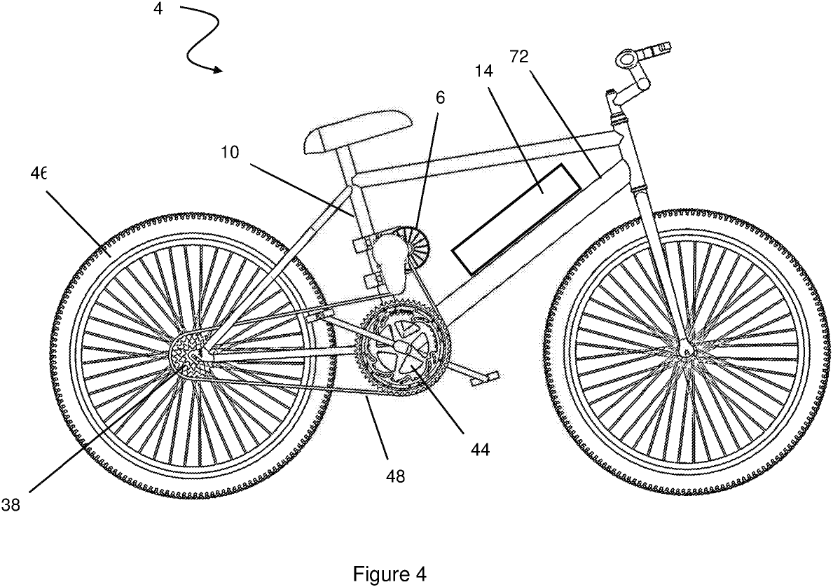

FIG. 3 shows a side view of the sprocket member;

FIG. 4 shows a side view of a second embodiment of the auxiliary motor arrangement mounted to a bicycle;

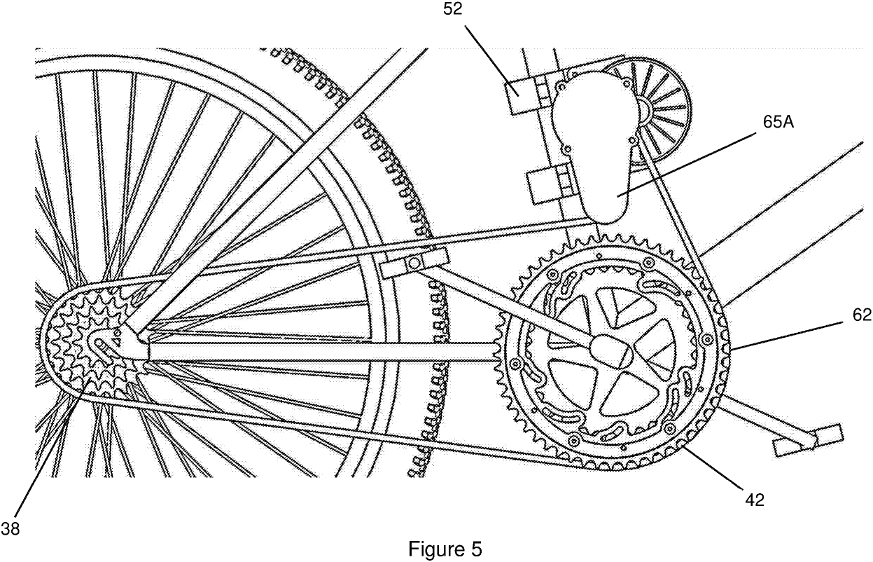

FIG. 5 shows a close-up side view of the second embodiment of the auxiliary motor arrangement mounted to a bicycle;

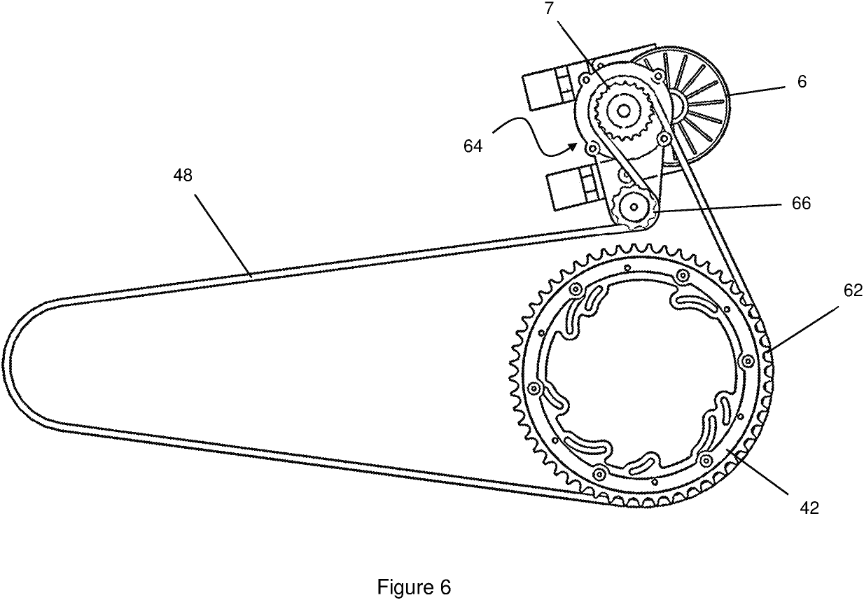

FIG. 6 shows a side view of the second embodiment of the auxiliary motor arrangement removed from the bicycle;

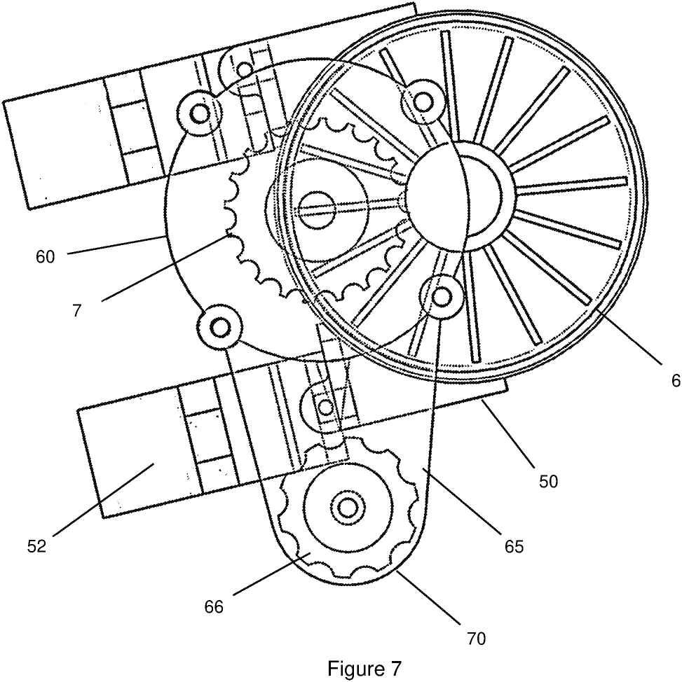

FIG. 7 shows a cut-away view of a motor of the auxiliary motor arrangement;

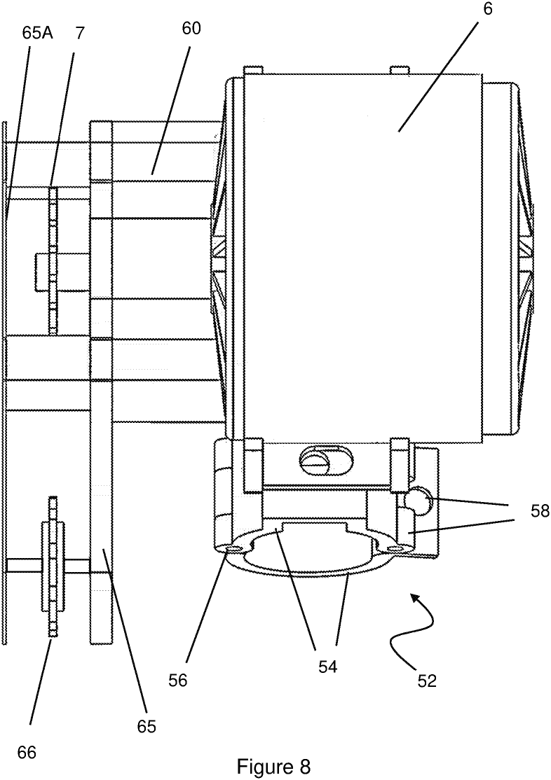

FIG. 8 shows a front view of the motor of the auxiliary motor arrangement;

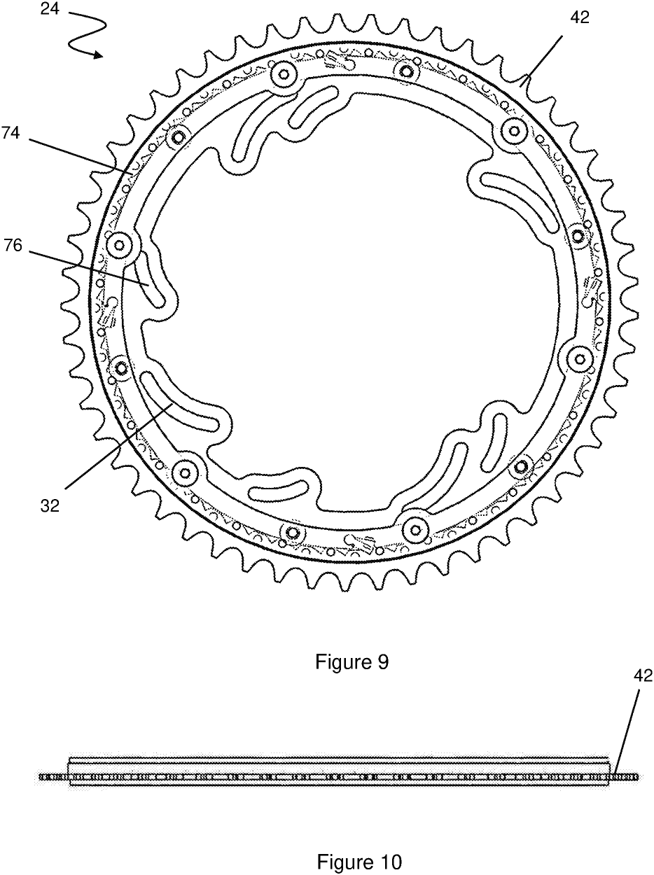

FIG. 9 shows a side view of a second embodiment of the sprocket member;

FIG. 10 shows a view from the edge of the second embodiment of the sprocket member.

FIG. 1 shows an auxiliary motor arrangement 2 mounted to a human powered vehicle 4, such as a pedal-powered vehicle. In the present embodiment, the vehicle 4 comprises a bicycle. However, it can be appreciated that the motor arrangement 2 may be used on other such human/pedal powered vehicles such as, unicycles, tricycles, pedal powered karts (i.e. with four wheels) etc.

The motor arrangement 2 comprises a motor 6 configured to provide mechanical power to propel the vehicle 4, along with an associated transmission system. The motor 6 comprises an electric motor, such as DC motor.

The motor 6 is attached to the frame 8 of the bicycle in use. In the present embodiment, the motor 6 is attached to seat tube 10, however, it can be appreciated that the motor 6 may be attached at any convenient location on the vehicle. The motor 6 is removably attached to vehicle 4, for example, using a bracket 12. The bracket may clamp onto the relevant frame member. The bracket 12 may comprise a single fixing screw, e.g. to allow easy attachment/detachment.

The motor 6 is therefore retrofittable to the vehicle 2.

The motor 6 comprises a sprocket 7 rotatably connected thereto. The sprocket 7 may be attached to and/or driven by the motor via a ratchet or other unidirectional drive arrangement. Thus the sprocket 7 is driven by the motor 6 in a first direction of rotation but may freewheel in the opposing direction. That is to say an output shaft of the motor 6 rotates in unison with the sprocket 7 in the first direction but relative rotation is permitted in the opposing direction.

The motor 6 is powered by a portable power supply 14. The power supply 14 comprises a battery system. The battery system comprises one or more removable battery supported within a battery housing 16. The battery is selectively removable from the housing to allow replacement thereof. This allows a fully or partially discharged battery to be replaced with a fully charged battery, thus mitigating the requirement for the user to wait for battery charging etc. The battery comprises a rechargeable battery, for example: a lattice structure ion transfer battery (e.g. lithium ion battery); advance lattice structured, high surface-flow batteries; Nickel-cadmium; Nickel-Metal Hydride; Lead-Oxide; or other conventional battery.

The power supply 14 is mounted to the frame 8, for example, behind a seat 18. The power supply 14 may be mounted to a conventional luggage rack or the like. The power supply 14 could be mounted to one or more support arm depending radially outward from a portion of the frame or axle supporting the rear wheel. Alternatively, the power supply 14 could be mounted to the frame by a bracket in a manner similar to the bracket 12 described above or at another portion on the frame. FIG. 1 shows a plurality of additional/alternative power supply 14 locations using dashed lines, which may be used for various different embodiments of the invention. The alternative locations may provide storage points for further power supplies, i.e. in addition to the power supply that is in use, on the bicycle. Additional batteries may be carried in this manner to allow replacement of a spent battery, if desired. A spent battery may also be stored on the bicycle when not in use.

The power supply is electrically connected to the motor 6. An electronic controller for the motor 6 may be mounted with the motor 6, i.e. on the same chassis as the motor 6 and/or within the motor housing. The electronic controller could be mounted with the power supply 14 or at another location on the vehicle 4 and in communication with the motor.

The power supply 14 and/or motor 6 is operatively connected to a manual controller/actuator 20 in the form of a throttle. The throttle 20 allows selective actuation of the power supplied to the motor 6, thereby activating or deactivating the motor 6.

In one example, the manual controller could provide a simple switch to turn on/off the motor 6. However the throttle 20 will typically allow for variable control of the speed at which the motor 6 operates, i.e. by varying the supply of power thereto from the power supply 14.

The throttle 20 is provided on the handle bars 22, however, it can be appreciated that the throttle may be provided on any suitable location preferred by the user. The throttle may comprise a rotatable handle portion, a lever, one or more button/switch, or similar.

The power supply 14 comprises electronic control circuitry to control power to the motor, for example, in response to the position of the throttle. The control circuitry may comprise voltage and/or current regulation., as will be understood by the person skilled in the art.

As shown in FIGS. 2 and 3, the transmission system of the auxiliary motor arrangement 2 comprises a sprocket member 24 (i.e. as may otherwise be referred to as a toothed wheel, gear wheel or cog member). The sprocket member 24 is configured to be selectively attached to a conventional sprocket forming part of the drivetrain of the bicycle, i.e. the main sprocket driven by the pedals of a conventional bicycle.

The sprocket member 24 comprises a plurality of spokes 26 extending between a central/hub portion 28 and outer annular portion 30 thereof. The spokes 26 comprise an elongate slot 32 extending along the axial length thereof.

The elongate slot 32 is configured to movably receive a fastener 33 (e.g. a nut and bolt) therein. Whilst only one fastener 33 is shown in FIG. 2, it will be appreciated that each slot 32 will typically have its own fastener.

The sprocket member 24 is configured to be larger than a conventional bicycle sprocket, such that the fasteners 33 mounted within the respective slots 26 can engage an outer edge of the bicycle sprocket and be mounted within respective teeth thereon. That is to say the fasteners 33 can engage the teeth of a conventional bicycle sprocket.

Alternatively, the fasteners 33 may engage apertures on the bicycle sprocket configured to allow attachment of a chain guard (i.e. the sprocket may replace the chain guard). For example, the fasteners 33 may be screwed into apertures provided on spokes of the bicycle sprocket.

The sprocket member 24 is thus clamped on the bicycle sprocket via the fasteners and the sprocket member 24 can rotate with the existing bicycle sprocket when mounted thereto. The sprocket member 24 thus provides a bespoke sprocket attachment for an existing bicycle sprocket to adapt it for use with the motor 6. The sprocket member provides at least one sprocket, i.e. an annular array of gear teeth, disposed radially outside of the existing sprocket teeth.

The fastener 33 is selectively engageable with the spoke 26 (i.e. the nut is tightened against the bolt to clamp the spoke 26 therebetween), such that its position along the elongate slot 32 may be varied. The fasteners 33 can therefore be adjusted in position along the slot 32 to accommodate varying sizes of bicycle sprocket.

In the present embodiment, the sprocket member 24 is attached to the bicycle sprocket comprising a manual actuator (i.e. the pedals 34). The central portion 28 of the sprocket member 24 comprises an aperture 36 therein of size and shape sufficient to receive the pedal 34. This allows the sprocket member 24 to be mounted to the existing bicycle sprocket without removing the pedals, i.e. by moving the aperture 36 over the pedal and then affixing member 24 to the existing sprocket.

As shown most clearly in FIG. 3, the sprocket member 24 comprises a first sprocket 24A and a second sprocket 24B. The first and second sprocket are provided in a side-by-side arrangement and are aligned with one another (e.g. are coaxial). A gap 39 is provided between the sprockets 24A and 24B, e.g. a lateral gap or clearance sufficient to accommodate a different chain on each sprocket.

The first sprocket 24A is configured to be operatively connected to the motor 6 in use. The first sprocket 24A is connected to the motor 6 via a chain 15A or the like (see FIG. 1) attached around the motor sprocket 7, i.e. forming a loop around sprockets 24A and 7.

The second sprocket 24B is configured to be operatively connected to a drive train of the bicycle. In the present embodiment, the second sprocket 24B is connected to rear wheel sprocket 38 via a chain 15B (see FIG. 1) or the like, i.e. forming a loop around sprockets 24B and 38.

Whilst the first 24A and second 24B sprocket are shown as being of the same diameter, they could be of differing diameters in other examples. They could have the same or different numbers of teeth. The chains used are conventional in form and will not be described for brevity.

The first and second sprocket may be provided as a single/fixed structure. The first and second sprocket are mounted using a common mounting/hub structure (e.g. the spokes 26, central portion 28 and outer portion 30).

The sprocket arrangement 24 comprises a rachet arrangement 40. The ratchet arrangement 40 allows rotation of the first 24A and/or second 24B sprocket (i.e. the sprocket teeth 42) relative to the outer portion 30 of the sprocket member 24 in a first direction, but prevents relative rotation in a second direction. The sprocket teeth 42 are therefore attached to the hub structure (e.g. the outer potion 30) via the ratchet mechanism 24

Taking FIG. 2 as an example, this allows transmission of power from the pedals when rotated in the clockwise direction (i.e. when pedalled forward) as the rachet is engaged, causing the hub and sprocket to rotate in unison. However the ratchet allows the pedals to be moved clockwise or remain idle as the rachet is disengaged in the opposing direction. This prevents the pedals from being driven when the user is idle or if the pedals are being rotated slower than driven rotation of the sprocket 24 by the motor 6, thereby reducing the likelihood of injury to the user.

A ratchet arrangement 40 is interposed between the outer portion 30 and the first and second teeth. The ratchet arrangement 40 is substantially annular.

The auxiliary motor arrangement 2 provides power to the drive train of the bicycle. This reduces the effort required by the user to drive the vehicle. The auxiliary motor arrangement 2 may be used on conjunction with the user’s power input (i.e. pedalling) or may be used to provide all of the driving power. Additionally, the system allows the user to operate the bicycle in a conventional fashion, by using human power only.

The ratchet arrangement described herein means that the user does not pedal against the resistance of the motor when it is inactive.

The rear wheel sprocket 38 may also comprise a ratchet.

The power supply 14 may vary the power supplied to the motor 6 according to the user control input via the control interface 20. Various modes of control and associated sensors could be used. For example, electric power to the motor could be cut when the brakes are applied Additionally or alternatively, the auxiliary motor arrangement 2 may be configured to provide a fixed speed of the vehicle 2 or a fixed torque output. The vehicle 2 may comprise a speed or torque sensor, and the power to the motor 6 is therefore adjusted to provide the correct speed or torque output. The power to the motor 6 could compensate for the user power input, for example, if the user power decreases, then motor power increase to maintain the correct speed/torque. The system could therefore balance the power provided by the motor 6 and the user, to provide a consistent torque/speed at the driven wheel. In other examples, the electrical motor could be driven to provide a constant, low level electrical assistance. Various implementations of differing control complexity are available using the auxiliary motor arrangement 2 described herein.

A charging station (not shown) may be provided to provide charging the battery. The charging station may charge two or more batteries simultaneously. The charging station may comprise a rack to accommodate the plurality of batteries. Rapid swapping of batteries on the bike may be available to minimise waiting/charging time.

A quick release mechanism may connect interchangeable batteries/cells to the battery housing 16. This provides a “plug and play” type arrangement.

The present invention allows retrofitting of an auxiliary motor arrangement to a conventional bicycle without any underlying modification thereof. The arrangement therefore converts a conventional bicycle into a power-assisted bicycle. The auxiliary motor arrangement may be easily removed and installed, thus providing a flexible system that can be implemented by the end user at will and at relatively low cost. This mitigates the need for a user to have a separate electric bicycle and a conventional bicycle. It also allows users to repurpose an existing bicycle, e.g. to try out electric assistance without needing to invest significant cost. The invention allows an existing bicycle to be modified whilst retaining the same kit, to which the owner is already accustomed.

Additionally, the invention could allow the manufacturer of a bicycle to produce a conventional bicycle and an electrically powered bicycle using the same base bicycle model, thus saving costs. Consumers can be given the option of electric or non-electric versions of the same bike model.

The sprocket arrangement can be attached to the bicycle sprocket easily and quickly, using conventional tools and without specialist skills.

Once installed, this retrofit solution allows fully manual drive, electrical assistance combined with manual drive, or fully electrical drive without requiring modification by the user to achieve each different mode.

In developments of the above-described concepts, there has been devised a revised auxiliary drive system which has only a single chain, rather than the two chain system of FIGS. 1-3. The revised system is shown in FIGS. 4-10.

The revised system shares with the auxiliary drive system of FIGS. 1-3 the free hub/rachet mechanism provided on the pedal driven gear. Thus the auxiliary drive system has a motor that drives through the existing pedal drive chain system of a pedal bike. The battery 14 is shown in a particular configuration in FIG. 4 but could take any of the locations described in relation to FIG. 1.

The revised system of FIGS. 4-10 comprises a single chain that passes around the pedal-driven gear 44, the driven gear 38 on the rear wheel (e.g. the gear cassette) and the motor gear 7 (see FIG. 6). The revised system may include an additional intermediate gear, e.g. an idler gear, as a guide for the chain as will be described below.

A direct force/drive path is therefore provided between the motor 6 and the rear wheel 46 (i.e. the motor 6 and the rear wheel gear 38 are directly connected by the chain 48). As such, the pedal gear 44, the rear wheel 46 and the motor 6 are all operatively connected via single force path, i.e. by the drive loop provided by the chain. This provides a simple arrangement and mitigates the need for the two separate chain systems in the system of FIGS. 1-3.

The system is shown in closer details in FIGS. 7 and 8. The motor 6 is supported by a carriage 50. The carriage 50 is then mounted to the bicycle 4. In the present embodiment, the carriage 50 is mounted to the seat tube 10. The carriage 50 is mounted using a clamp 52. The carriage 50 is therefore dismountable from the bicycle 4. As best seen in FIG. 8, the clamp 52 comprises a pair of opposed, U-shaped or C-shaped brackets 54, e.g. being semi-circular in plan. The brackets 54 are connected via a pivot joint 56. A securing means, such as a pin or bolt (not shown), may hold the brackets 54 together, thus securing the carriage 50 on the bicycle 4. Respective apertures 58 are provided to allow attachment of the securing means.

It can be appreciated that any suitable alternative means may be provided to mount the motor 6 to the bicycle 4. However, the present embodiment, allows a “quick release” arrangement for convenient mounting/unmounting of the system 2 in a modular fashion. This allows adjustment of the distance between the motor 6/motor gear 7 and the pedal gear 44 (i.e. in vertical direction) to ensure correct tensioning of the chain.

The attachment formations (e.g. the clamp 52) for attaching the sprocket member to the pedal-driven gear of the bike have been modified for ease of manufacture and for universal fit on the significant majority of existing pushbike models.

In some embodiments, the carriage 50 may connect to bottle/cage mounts provided on the bicycle, e.g. in the form of holes. The carriage 50 may comprise formations configured to engage the mounts and may take the form of projections or apertures. The formations may be spaced by a conventional spacing (e.g. 64 mm) to match the mounts.

In some embodiments, the carriage 50 comprises an adjustment means to allow adjustment of the position of the motor 6/motor gear 7 (i.e. translation thereof) once mounted to the bicycle 2. This may be beneficial, for example, where the carriage 50 is mounted to the cage mounts, and thus are provided in a fixed position.

The adjustment means may provide adjustment in one or a plurality of dimensions (e.g. one, two or three dimensions). For example, the position of the motor 6/motor gear 7 may be adjustable in an up/down direction (i.e. along the axis of the seat tube 10), a forward/backward direction (i.e. toward the front/rear wheel of the bicycle) and/or a sideways direction (in/out of the plane of the page).

The adjustment means may comprise any suitable mechanism to effect movement of the motor 6 and/or the carriage 50 relative to the clamp 52. For example, the adjustment means may comprise a screw/worm adjuster, rack and pinion, adjustable clamp etc. This allows fine adjustment of the position of the motor gear 7 to ensure correct alignment with the pedal gear 7 (e.g. to ensure they are coplanar), thus preventing unnecessary wear and/or friction.

In the present example, it has been found that the provision of slots and fasteners received therein can provide for suitable manual adjustment. That is to say relative adjustment of the motor relative to the clamps can be effected by movement along one or more slot to ensure the correct tension in the chain and/or that the motor gear is in line with the pedal sprocket (e.g. in a vertical plane therewith). The fasteners can then be applied to lock the correct position along the relevant slot.

In some embodiments, the adjustment means may allow rotation of the motor 6/motor gear 7. Rotation may be provided in one, two or three rotational axes.

A gearbox 60 is operatively connected to the motor 6. The motor gear 7 is operatively connected to the gearbox 60. The gearbox 60 thus provides a gearing mechanism and a mounting point for the motor gear 7. The positions of motor 6 and the motor gear 7 are therefore fixed relative to one another. Other arrangements of motor and gear(s) can be used, such as brushless DC motor and planetary gear arrangements, e.g. to reduce weight/size if desired.

A unidirectional ratchet is provided between the gearbox 60 and the motor gear 7. The rotational axis of the motor gear 7 and the motor 6 are offset. This allows the motor 6 to mounted to the seat tube 10, whilst allowing the motor gear 6 to be mounted directly above the pedal sprocket 42. This also reduces the width of the system 2 (i.e. in/out of the page).

As shown best in FIGS. 5 and 6, the motor gear 7 is mounted behind the front edge 62 of the pedal sprocket 42 (i.e. offset therefrom). Thus, the chain 48 engages the pedal sprocket 42 over an arc length of greater than 90°. This ensures the chains 48 remains in drivingly engaged with the pedal sprocket 42. In the present embodiment, the axis of rotation of the motor gear 7 may be provided substantially vertically above the axis of rotation of the pedal gear 44. Thus the angle subtended by the respective axes of rotation of the rear gear 46, pedal gear 44 and the motor gear 7 may be approximately 90°. However, the reduced diameter of the motor gear 7 and/or driven gear 38 relative to the pedal sprocket 42 helps ensure a greater than 90° arc length of contact between the chain and pedal sprocket 42.

A conventional derailleur (not shown in the figures) for the driven gear 38 may help retain adequate tension in the chain.

The drive/motor arrangement comprises a guide/tensioning mechanism 64 in the form of an idler gear. The guide mechanism 64 is configured maintain a desired tension and/or alignment of the chain 48 as it passes onto the motor gear 7. This may accommodate different sprocket 42 size and/or different positioning of the motor gear 7. The guide mechanism 64 comprises an arm 65, e.g. provided as an integral portion of the motor assembly or carriage, configured to hold the gear 66 at a suitable radial spacing and/or orientation relative to the motor gear 7. The guide mechanism 64 may be referred to as a derailleur.

In the present example, the arm 65 is provided as a back plate to which both the motor and gear 66 are mounted in a fixed relationship. The back plate arrangement helps partially enclose the chain in the vicinity of the gear 66 and motor 6. As can be seen in FIGS. 5 and 8, the arm 65 may comprise front plate 65A also such that the chain and gears are held between the front and back plates. The plates may therefore be provided on opposing sides of the gear 66, gear 7 and chain 48. The arm 65 thus provides a housing/enclosure for the chain and gear(s) as it passes around the motor gear. This can prevent the user’s clothes, etc. becoming trapped in the tensioning mechanism 64 in use and also inhibits insertion of objects into the chain path around the gears, e.g. acting as a chain guard specific to the motor gear arrangement. The back 65 and/or front 65A plate could comprise an intermediate/side wall with openings to receive the chain to enclose the mechanism more fully and help prevent ingress of dirt/debris.

In the present embodiments it is envisaged that a conventional derailleur is used on the gear 36 of the rear wheel 46. As such, adequate tension is provided in the chain, whilst allowing some flexibility in the precise positioning of the motor gear 7 for a given length of chain. However in the event that a conventional derailleur is not provided (e.g. in a fixed rear gear arrangement), or else if the rear derailleur does not provide sufficient variation in chain length/tension, the gear 66 could provide a tensioning means for the chain in addition to its primary function to align the chain onto the motor gear 7.

In some examples, the arm 65 could be reconfigured to allow rotation relative to the carriage 50. The arm 65 could be mounted to the carriage via a pivot 68 (see FIG. 7). The pivot 68 is co-axial with the motor gear 7. In such examples, the arm 65 may comprise a biasing means to maintain tension and/or alignment in the chain, e.g. in the form of a derailleur. The biasing means may comprise any suitable means, for example, a torsion spring. The biasing force of any rear wheel tensioning member and the motor tensioning member 64 may be balanced to ensure one of the tensioning member does not overextend the other.

The gear 66 is mounted is rotatably mounted at a distal end 70 of the arm 65, spaced from the pivot 68. The chain 48 passes over the motor gear 7 and the gear 66 in a serpentine or “S-shaped” manner as can be seen in FIG. 6. The gear 66 thus holds the chain 48 onto the motor gear 7. The guiding of the chain in this manner can create a long contact path of the chain on the motor gear, e.g. such that the chain maintains contact with the motor gear 7 over an angle of greater than 120°. An angle of up to, or greater than 180° is achievable and has been found to be beneficial so that the driving force applied by the motor gear is correctly transmitted through the chain.

The guide/tensioning mechanism 64 can act to increase the path length of the chain 48, maintaining the correct alignment and/or tension thereof.

The chain 48 passes around the motor gear 7 by an arc length angle greater than 180 in this example, e.g. maintaining maximum gear teeth engagement. The gear 66 may orient the chain beneath the motor gear for this purpose. However, it can be appreciated, that if a greater effective chain length is required, the arc length of engagement may decrease and/or increase if the gear 66 is no longer vertically beneath the motor gear 6. It can be appreciated that the arc length could be between 90 and 200 degrees.

Instead of a conventional drive loop having two ends passing around a pedal-driven sprocket and a driven-wheel sprocket respectively, the drive loop described herein passes around three sprockets, where one is the motor sprocket. The chain path is modified to create a further portion (e.g. an additional corner/extension loop) to pass around the motor sprocket and thus follows a longer path than a conventional chain.

As shown in FIG. 4, the battery 14 is mounted to the frame using conventional openings on the frame, e.g. cage mounts typically used for mounting accessories such as a water bottle holder or the like. The battery 14 is mounted to the “down tube” 72. This provides a low centre of the gravity. The battery 14 is also near the centre of mass of the bicycle 4, thus providing a stable arrangement. Wiring from the battery 14 to the motor 6 may be follow the frame (e.g. along the down tube 72 and up the seat tube 10).

The sprocket member 24 is shown in FIGS. 9 and 10. Due to the single chain arrangement, the sprocket only comprises a single gear sprocket 42. A ratchet mechanism 74 ensures one-way drive through the pedal driven sprocket 42. The ratchet mechanism 74 may comprise any suitable mechanism.

In this embodiment, the mounting slots 32, extend in a circumferential direction. The slots 32 thus extend in both a radial and circumferential direction. This allows accommodation of both different radially sized pedal sprockets 44 and differing tooth spacing. The slots 32 are curved and may be described as part spiral or helical in form. The slots 32 curve inward (i.e. the radial component of the slots 32 increase toward a radially inner end of the slot).

Indicia or increments may be provided to indicate a number of standard pedal sprocket 44 sizes.

A second plurality of slots 76 are provided. The second slots 76 may be substantially the same as the first slots 32 or different in form. The second slots 76 may comprise a different circumferential spacing to the first slots 32 and/or different slot length. In the example, shown in FIG. 9, four first slots 32 and five second slots 76 (with one first and second slot coinciding) are provided. This increases the range of pedal sprockets 44 in which the sprocket member 24 may be attached.

The different slots 32/76 may overlap at certain portions of the sprocket circumference.

Various conventional configurations for the pedal sprocket can be accommodated using the shown slot arrangement, including either or both of the five-slot array 76 and/or the four-slot array 32. The ability to fit to the significant majority of existing pedal sprocket configurations is particularly beneficial for a ‘one-size-fits-all’ retrofit solution.

It can be appreciated that any of the features hereinbefore discussed may be used with either embodiment of the invention, except where mutually exclusive. Although the present embodiment is configured to drive a rear wheel 46, in some embodiments, the system may drive a front wheel and/or any other wheel. In some embodiments, the chain 48 may comprise any suitable drive/endless loop (e.g. a belt or the like).

The sprocket member attached over the pedal-driven gear only requires a single gear/sprocket instead of the dual sprockets shown in FIG. 3. The single chain may avoid the offset of two chains provided side by side. This provides a thinner and less complex design. The single chain version may be easier to mount/align with the requisite tension in the chain and avoids any torque offset in the vertical plane, e.g. the motor gear 7 can be vertically aligned with the sprocket 42.

The single chain and tensioning mechanism can also reduce the need for perfect height alignment of the motor such that good engagement with the chain is maintained.

1. An auxiliary drive arrangement for a pedal-powered vehicle having a drivetrain comprising a drive loop for connecting pedals to a driven wheel via a pedal-driven sprocket, the auxiliary drive arrangement comprising:
an electric motor arranged to be mounted to the vehicle; and
a sprocket member configured to be attachable via an attachment formation to the pedal-driven sprocket within the drive train of the vehicle, wherein the sprocket member comprising a sprocket configured to be operatively connected to the electric motor.

2. An auxiliary drive arrangement according to claim 1, wherein the drive loop comprises a single chain and provides a drive path from the electric motor to a further sprocket on the driven wheel of the vehicle via the sprocket member.

4. An auxiliary drive arrangement according to claim 1, wherein the sprocket member is configured to be mounted about a rotation axis of the pedal-driven sprocket via an attachment formation.

5. An auxiliary drive arrangement according to claim 4, wherein the attachment formation is configured to engage teeth of the pedal-driven sprocket of the drivetrain.

6. An auxiliary drive arrangement according to claim 1, the electric motor comprises a motor gear, the motor gear being connected to an output shaft of the motor via a ratchet device.

7. An auxiliary drive arrangement according to claim 6, wherein an axis of rotation of the motor gear is offset from an axis of rotation of the electric motor.

9. An auxiliary drive arrangement according to claim 1, comprising an adjustment means configured to provide adjustment of the position of the electric motor and/or motor gear relative to the sprocket member.

10. An auxiliary drive arrangement according to claim 9, comprising a mounting means for mounting the electric motor to the vehicle, and the adjustment means provides adjustment of the position of the electric motor and/or motor gear relative to the mounting means.

11. An auxiliary drive arrangement according to claim 1, wherein an angle subtended between the motor gear, the sprocket member and a drive gear of the driven wheel is less than 110 degrees.

12. An auxiliary drive arrangement according to claim 1, wherein the electric motor is mounted to a seat tube of the vehicle or a housing tube for a saddle post.

13. An auxiliary drive arrangement according to claim 1, comprising a guide mechanism configured to be mounted on the electric motor and to deflect the path of the drive loop in the vicinity of the motor.

15. An auxiliary drive arrangement according to claim 13, wherein the guide mechanism defines a serpentine path for the drive loop in conjunction with the motor gear.

16. An auxiliary drive arrangement according to claim 4, wherein the attachment formation comprises a plurality of members selectively displaceable in a radial direction and/or circumferential direction.

17. An auxiliary drive arrangement according to claim 4, wherein the attachment formation comprises a fastener received within an aperture on the sprocket member, the fastener selectively engageable with the aperture to prevent relative movement there-between.

18. An auxiliary drive arrangement according to claim 17, wherein the aperture is elongate, in the form of a slot and the fastener is movable along the aperture such that the attachment formation is range-taking.

19. An auxiliary drive arrangement according to claim 18, comprising a plurality of first slots and a plurality of second slots, wherein the circumferential spacing the first plurality of slots is different to the spacing of the second plurality of slots.

20. An auxiliary drive arrangement according to claim 1, wherein the sprocket member is annular in form and comprises a central aperture configured to permit a pedal of the vehicle to pass therethrough.

21. An auxiliary drive arrangement according to claim 1, wherein the sprocket member is rotatably mounted to the attachment formation of the sprocket member via a ratchet device configured to allow relative movement there between in a first direction and prevent relative movement there between in an opposing direction.

22. An auxiliary drive arrangement according to claim 1, further comprising user controls arranged to control the level of power supplied to the motor from the power source and/or the speed of the motor.

23. An auxiliary drive arrangement according to claim 1, provided in the form of a kit of parts for retrofit to an existing pedal-powered vehicle, the kit of parts comprising:
the electric motor;
an electronic controller for the motor and/or a manual controller for the motor;
a power source; and
the sprocket member.

26. A sprocket member for a pedal-powered vehicle having a pedal assembly comprising pedals mounted for rotation about a pedal axis, the sprocket member comprising a sprocket and an attachment formation for mounting of sprocket to the pedal assembly about the pedal axis, wherein the sprocket member comprises a ratchet mechanism between the common attachment formation and the sprocket.
